(19) United States
(12) Patent Application Publication
(10) Pub. No.: US 2016/0313888 A1
(43) Pub. Date: Oct. 27, 2016

(54) GRAPHICAL USER INTERFACE FOR DISTRACTION FREE SHOPPING ON A MOBILE DEVICE

(71) Applicant: eBay Inc., San Jose, CA (US)

(72) Inventors: Anand Sekar Rengasamy Rajasekar, Cupertino, CA (US); Tharun Tej Tammineni, San Jose, CA (US); Vijayshree Singh, San Jose, CA (US); Xiaolin Wang, Sunnyvale, CA (US)

(21) Appl. No.: 14/697,468

(22) Filed: Apr. 27, 2015

(51) Int. Cl. G06F 3/0488; G06Q 30/06; G06F 3/0482; G06F 17/30

(52) U.S. Cl. CPC G06F 3/0488; G06F 17/30864; G06F 17/30905; G06Q 30/0625; G06Q 30/0641; G06F 3/0482

(57) ABSTRACT

In various example embodiments, a system and method for providing a graphical user interface on a client device are presented. The graphical user interface is configurable to operate in various operating modes. In a first operating mode, the graphical user interface displays search results received in a response to a search query. In a second operating mode, the graphical user interface displays individual search results, along with a primary image associated with the individual search result. In the second operating mode, a user may designate one or more search results for later review. Accordingly, in the third operating mode, the graphical user interface presents those search results that the user saved for review. While in the third operating mode, the user can choose whether to keep or remove a saved search result. Kept search results may then be purchased via the client device or from a different device if desired.

### TECHNICAL FIELD

Embodiments of the present disclosure relate generally to graphical user interfaces and, more particularly, but not by way of limitation, to a graphical user interface for distraction free shopping on a mobile device.

### BACKGROUND

Conventionally, a user uses a web browser, such as Microsoft Internet Explorer or Mozilla Firefox, to view items offered for sale online by a merchant. The merchant establishes a website that the user visits via the web browser, and then makes selections regarding one or more desired items via hyperlinks or other selectable elements displayed on one or more web pages of the website. However, the web pages will often have content that is not relevant to the items desired by the user or may be considered irrelevant to the user, such as advertisements, customer reviews, hyperlinks to similar items purchasable from other merchants, hyperlinks to items purchased by users that have purchased the item under consideration by the user, and other such content. This content is distracting and can result in the user purchasing the same item from another merchant that does not have the distracting content.

In addition, many users can use a smartphone or other mobile device, such as a tablet computer, to visit a merchant's website. However, the website is conventionally designed with a desktop or laptop computing platform in mind. Mobile devices, such as smartphones and tablets, have different display and input components than a desktop or laptop, and these conventionally designed websites make it difficult for the user to navigate when using a mobile device.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a block diagram illustrating various modules and data of a client device according to an example embodiment.

FIG. 3 illustrates a user interface of a client device operating in a first operating mode according to an example embodiment.

FIG. 4 illustrates the client device displaying the user interface operating in a second operating mode, according to an example embodiment.

FIGS. 5A-5B illustrate a user interacting with the user interface operating in the second operating mode, according to an example embodiment.

FIG. 6 illustrates the user further interacting with the user interface to change one or more images associated with an item, according to an example embodiment.

FIG. 7 illustrates a user further interacting with the user interface to change the displayed item, according to an example embodiment.

FIG. 8 illustrates the various ways a user may change a displayed item or an image of the displayed item using the user interface, according to an example embodiment.

FIGS. 9A-9B illustrate an additional interaction by the user with the user interface to save an item for later review, according to an example embodiment.

FIGS. 10A-10B illustrate the user interacting with an activation element displayable by a user interface, according to an example embodiment.

FIGS. 11A-11B illustrate the user interacting with the user interface operating in the third operating mode, according to an example embodiment.

FIG. 12 illustrate a flowchart of a method, according to an example embodiment, for causing the user interface to enter the second operating mode.

FIGS. 13A-13B illustrate a flowchart of a method, according to an example embodiment, for interacting with the user interface operating in the second operating mode.

FIG. 14 illustrates a flowchart of a method, according to an example embodiment, for interacting with the user interface operating in the third operating mode.

FIG. 15 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments, a user interface having multiple operating modes for viewing and interacting with items purchasable from a merchant's website is provided. The operating modes include, but are not limited, to a first operating mode that displays a list of items requested by a user (e.g., via a search query), a second operating mode that individually displays the items requested by the user and, if desired, to place an individually viewed item on a list for later review, and a third operating mode that allows a user to confirm that an item should be saved for purchasing later or request that an item be removed from the review list. When the user confirms that an item should be saved for purchasing later, the confirmation and the item are synchronized with a server such that the user can then purchase the item at a later item or in the event that the user decides to use a different device in purchasing the item. The user interface displays various activation elements (e.g., graphical buttons) that cause the user interface to switch between the various operating modes. In addition, the user interface is configured to receive input from physical gestures, and different commands are executed by the user interface depending on the direction of a given physical gesture and the duration of time in which the physical gesture is made.

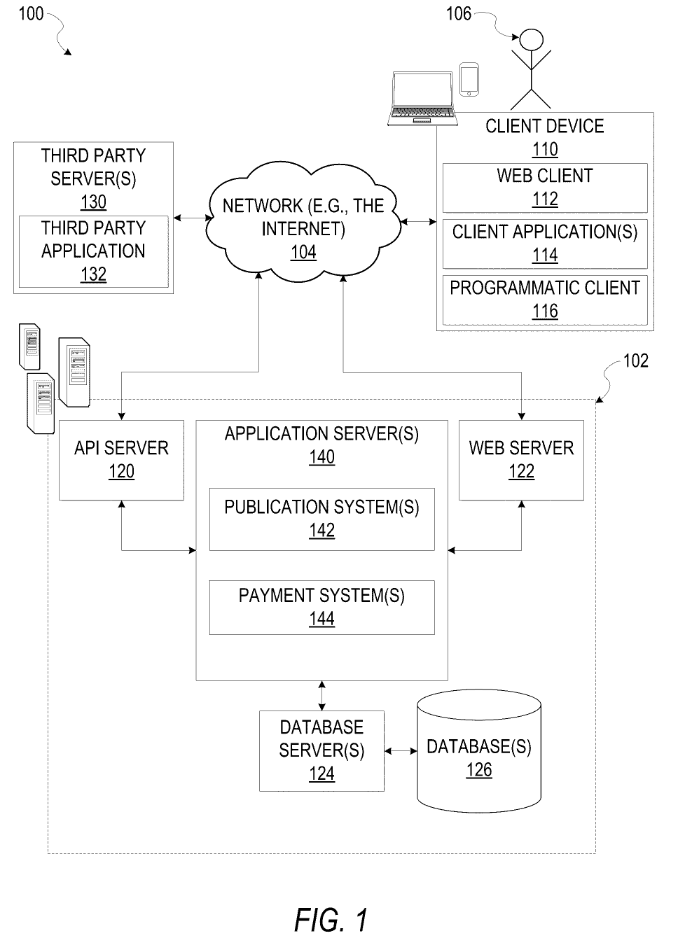

With reference to FIG. 1, an example embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), an application 114, and a programmatic client 116 executing on client device 110.

The client device 110 may comprise, but are not limited to, various types of mobile devices, such as portable digital assistants (PDAs), smart phones, tablets, ultra books, multi-processor systems, microprocessor-based or programmable consumer electronics, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions. One or more users 106 may be a person, a machine, or other means of interacting with client device 110. In embodiments, the user 106 is not part of the network architecture 100, but may interact with the network architecture 100 via client device 110 or another means. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device 110, then this application is configured to locally provide the user interface and at least some of the functionalities with the application configured to communicate with the networked system 102, on an as needed basis, for data and/or processing capabilities not locally available (e.g., access to a database of items available for sale, to authenticate a user, to verify a method of payment). Conversely if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user 106 provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user 106. In this way, the user 106 can interact with the networked system 102 using the client device 110.

An application program interface (API) server 120 and a web server 122 are coupled to, and provide programmatic and web interfaces respectively to, one or more application servers 140. The application servers 140 may host one or more publication systems 142 and payment systems 144, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 120. The databases 126 may also store digital item information in accordance with example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication system 142 provides a number of publication functions and services to users 106 that access the networked system 102. The payment system 144 likewise provides a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment systems 144 may form part of the publication system 142.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142 and payment system 144 could also be implemented as standalone software programs, which do not necessarily have networking capabilities.

The web client 112 may access the various publication and payment systems 142 and 144 via the web interface supported by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

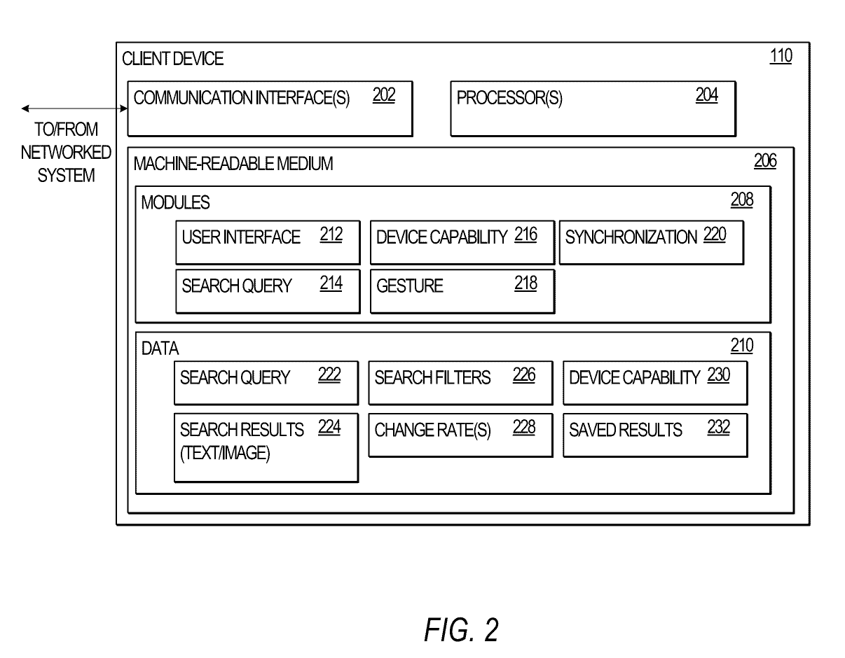

FIG. 2 is a block diagram illustrating various components of the client device 110 according to an example embodiment. In one embodiment, the client device 110 includes one more communication interfaces 202 in communication with one or more processors 204. The one or more processors 204 are communicatively coupled to one or more machine-readable mediums 206, which include modules 208 for providing the disclosed user interface and data 210 to support the execution of the modules 208. Furthermore, the one or more modules 208 and/or data 210 may be used to implement one or more of the web client 112, client application(s) 114, or programmatic client 116.

The various functional components of the client device 110 may reside on a single device or may be distributed across several computers in various arrangements. The various components of the client device 110 may, furthermore, access one or more databases, and each of the various components of the client device 110 may be in communication with one another. Further, while the components of FIG. 2 are discussed in the singular sense, it will be appreciated that in other embodiments multiple instances of the components may be employed.

The one or more processors 204 may be any type of commercially available processor, such as processors available from the Intel Corporation, Advanced Micro Devices, Texas Instruments, or other such processors. Further still, the one or more processors 204 may include one or more special-purpose processors, such as a Field-Programmable Gate Array (FPGA) or an Application Specific Integrated Circuit (ASIC). The one or more processors 204 may also include programmable logic or circuitry that is temporarily configured by software to perform certain operations. Thus, once configured by such software, the one or more processors 204 become specific machines (or specific components of a machine) uniquely tailored to perform the configured functions and are no longer general-purpose processors.

The one or more communication interfaces 202 are configured to facilitate communications between the client device 110 and the network system 102. The one or more communication interfaces 202 may include one or more wired interfaces (e.g., an Ethernet interface, Universal Serial Bus (“USB”) interface, a Thunderbolt® interface, etc.), one or more wireless interfaces (e.g., an IEEE 802.11b/g/n interface, a Bluetooth® interface, an IEEE 802.16 interface, etc.), or combination of such wired and wireless interfaces.

The machine-readable medium 206 includes various modules 208 and data 210 for providing the disclosed user interface and for facilitating the selection of one or more items purchasable via the networked system 102. The machine-readable medium 206 includes one or more devices configured to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the modules 208 and the data 210. Accordingly, the machine-readable medium 206 may be implemented as a single storage apparatus or device, or, alternatively and/or additionally, as a “cloud-based” storage systems or storage networks that include multiple storage apparatus or devices. As shown in FIG. 2, the machine-readable medium 206 excludes signals per se.

In various embodiments, the modules 208 include a user interface module 212, search query module 214, a device capability module 216, a gesture module 218, and a synchronization module 220.

The user interface module 212 is configured to provide a user interface, such as a graphical user interface, for interacting with the client device 110 and communicating with the networked system 102. In one embodiment, the user interface module 212 provides the graphical user interface via a programmatic client installed on the client device 110. In another embodiment, the user interface module 212 provides the graphical user interface via a web service accessible by a web browser installed on the client device 110. The graphical user interface provided by the user interface module 212 facilitates interactions between a user of the client device 110 and the networked system 102, including the publication system(s) 142, the payment system(s) 144, or both. These interactions include, but are not limited to, accessing a member profile, providing a search query, refining the search query with one or more filters, viewing one or more search results in response to the search query, selecting one or more of the search results and other such interactions.

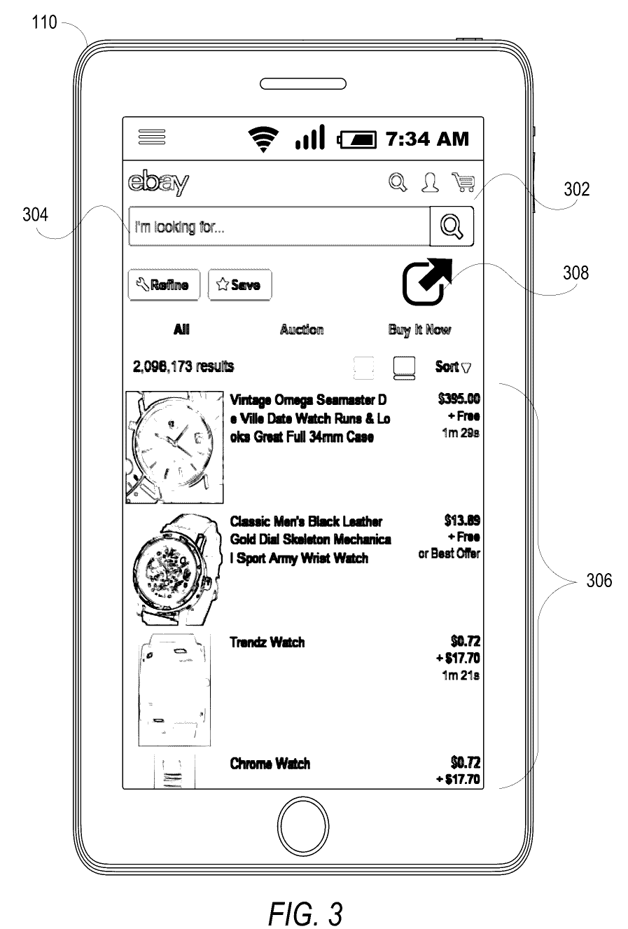

FIG. 3 illustrates a user interface 302 of the client device 110 operating in a first operating mode according to an example embodiment. In the first operating mode, the user interface module 212 is configured to implement a user interface 302 that displays a search query element 304, which is implemented by the search query module 214. The search query element 304 is configured to receive a search query, such as text comprising one or more alphanumeric characters, and communicate said search query to the network system 102 via the one or more communication interfaces 202. In one embodiment, the search query communicated by the search query module 214 is implemented one or more computer programming and/or scripting languages, such as JavaScript, PHP, SQL, DHTML, and other such computer programming and/or scripting languages. In addition, the user interface 302 may be configured to display one or more search filters, such as search filters 226, which define various attributes relating to items offered by an electronic marketplace to assist a user in refining his or search query. Examples of search filters 226 include a price range, a physical condition (e.g., new or used), the manner of purchasing the item (e.g., auction or no auction), how other customers have rated a given item, and other such search filters.

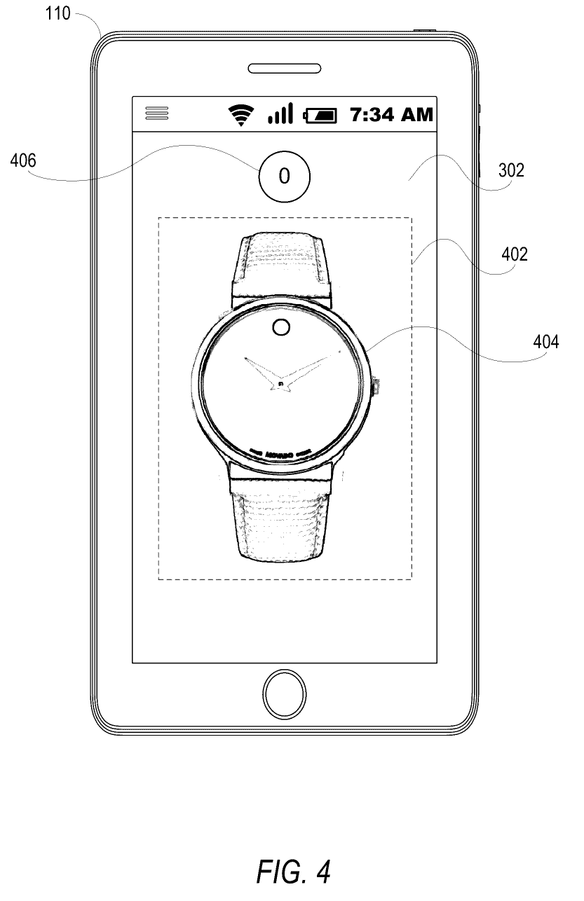

When the networked system 102 provides a response to the search query, the search query module 214 communicates the received response to the user interface module 212, which then displays the response via the user interface 302. In one embodiment, the search query module 214 receives one or more search results (e.g., search results 306) in response to the received search query. The search results may include one or more elements of text, graphics, sounds, and other such audiovisual content. As discussed below with reference to FIGS. 4-8, the search results may include items satisfying the received search query, and each search result may further include one or more images of said search result, where one of the images is designated the “first” or “primary” image. In one embodiment, the search results, along with the primary image, are displayed via the user interface 302.

In addition, the search query module 214 is configured to store the search query entered via the search query element 304 and the search results 306 received in response thereto. In one embodiment, the entered search query is stored as search query data 222 and the displayed search results 306 are stored as search results 224, which, as discussed, may include additional elements (e.g., text and/or graphics) not displayed on the user interface 306 operating in the first operating mode.

As shown in FIG. 3, the first operating mode of the user interface 302 is configured to display the received search results as a set of search results. Accordingly, displaying the search results in this manner occupies a non-trivial portion of the display of the client device 110. Further still, as each of the search results 306 may include one or more images, such images may be displayed at a reduced resolution to accommodate the display of the search results 306.

Accordingly, the user interface 302 is configured to implement a selectable element 308 that, when selected, causes the user interface 302 to enter in a second operating mode. In one embodiment, the selection of the selectable element 308 is detected by the gesture module 218, which interprets input received from an input component of the client device 110, such as touch-sensitive display, into a command executable by one or more of the modules 208. In this regard, the touching of the selectable element 308 is interpreted as a command by the gesture module 218 that the user interface module 212 should change the operating mode of the user interface 302.

FIG. 4 illustrates the client device 110 displaying the user interface 302 operating in a second operating mode, according to an example embodiment. In the second operating mode, the user interface 302 is configured to display individual search results, such as the search result 402, from the received set of search results 224. As mentioned above, each of the received search results may include one or more associated images. In one embodiment, one of the images is designated the “primary image,” which is displayed via the user interface 302 when the user interface 302 is operating in the second operating mode. As shown in FIG. 4, a primary image 404 is initially displayed when the user interface 302 initially displays the search result 402.

In addition to one or more images, and as discuss above, the search result 402 may include text that describes the search result, such as the item being viewed, the cost of the item, the seller of the item, the amount of time remaining before the item is no longer available (e.g., where the item is being auctioned), and other such textual information. However, in one embodiment, this textual information may be suppressed or omitted from the display of the search result 402. As discussed below, the gesture module 218 is configured with a command that interprets a gesture by the user of the client device 110 that causes the display of the associated textual information (or a portion thereof).

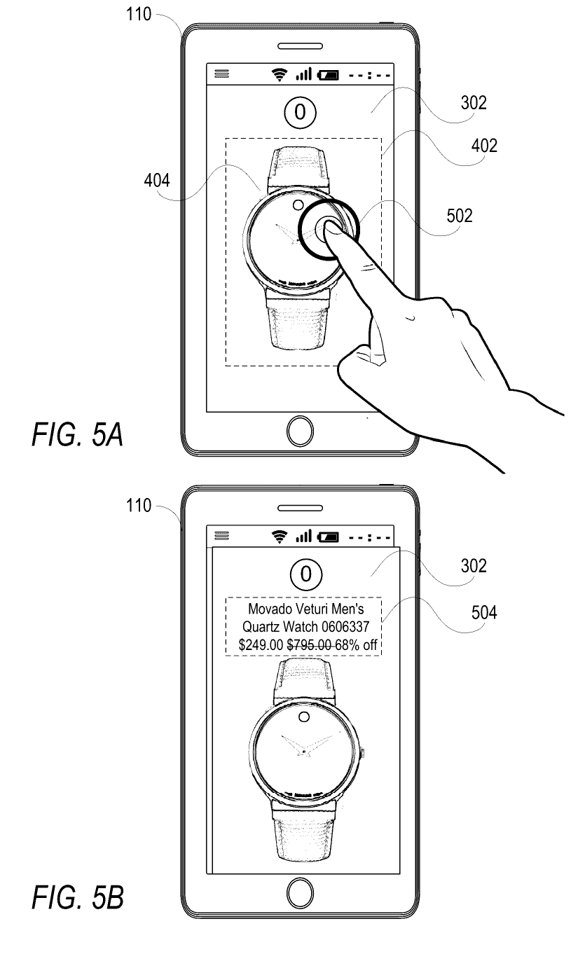

FIGS. 5A-5B illustrate a user interacting with the user interface 302 operating in the second operating mode, according to an example embodiment. In one embodiment, when the user performs a predetermined gesture 502 on the input component of the client device 110, the gesture module 218 interprets the predetermined gesture 502 as a command. For example, the data 210 may include a plurality of predetermined gestures, where each gesture is associated with a corresponding command. As shown in FIG. 5A, when the user provides the predetermined gesture 502, such as by touching (e.g., tapping) the image 404 of the search result 402, the gesture module 218 interprets the tap as a request to display the text associated with the corresponding search result 402. Accordingly, FIG. 5B illustrates the user interface 302 displaying the textual information 504 associated with the search result 402. In one embodiment, the textual information 504 is displayed above the image 404 of the search result 402; however, other placements of the textual information 504 are also possible, such as below the image 404, on either side of the image 404, overlaid the image 404, and in other such placements.

In addition to the image 404 associated with the search result 402, the search result 402 may include additional images. Thus, the image 404 may be considered the primary image, which is displayed when the search result 402 is initially displayed on the user interface 302. However, the search result 402 may be associated with additional images, which may be stored as part of the search results 224. Alternatively, the additional images may reside on a repository remote from the client device 110, such as the database 126, and are transferred to the client device 110 when requested.

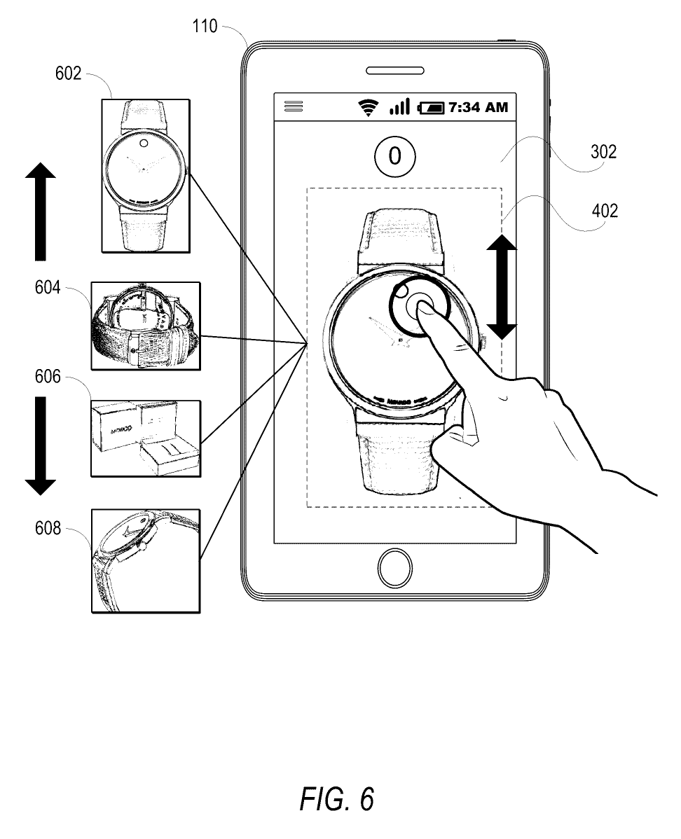

Accordingly, FIG. 6 illustrates the user further interacting with the user interface 302 to change one or more images 602-608 associated with the search result 402, according to an example embodiment. In one embodiment, the user changes the image displayed on the user interface 302 by performing a predefined gesture on an input component (e.g., a touch-sensitive display) of the client device 110. Such a physical gesture may be made with a physical object, such as the user's finger, a stylus, a pen, other input component. The physical gesture made by the user is interpreted as a command by the gesture module 218.

In one embodiment, the physical gesture is defined by motion occurring in an axis (e.g., horizontal or vertical) relative to the input component and a time or contact duration. For example, where the user performs an upward vertical physical gesture relative to the input component and remains in contact for a predetermined amount of time during that motion (e.g., one second), the gesture module 218 identifies the physical gesture as the command to display the “next” image (e.g., image 604 if the displayed image is image 606) associated with the displayed search result. As another example, where the user performs a downward vertical physical gesture relative to the input component and remains in contact for another predetermined amount of time during that motion (e.g., one second), the gesture module 218 identifies the physical gesture as the command to display the “previous” image (e.g., image 606 if the displayed image is image 604) associated with the displayed search result. In addition, where the user interface module 212 determines that there are no “next” images or “previous” images, the user interface module 212 displays the first image 602 as the previous image or the last image 608 as the next image, depending on whether the “previous” command or “next” command is performed on the last image 608 or the first image 602, respectively. In this manner, the user interface module 212 performs a “wrap-around” of the images associated with the search result 402.

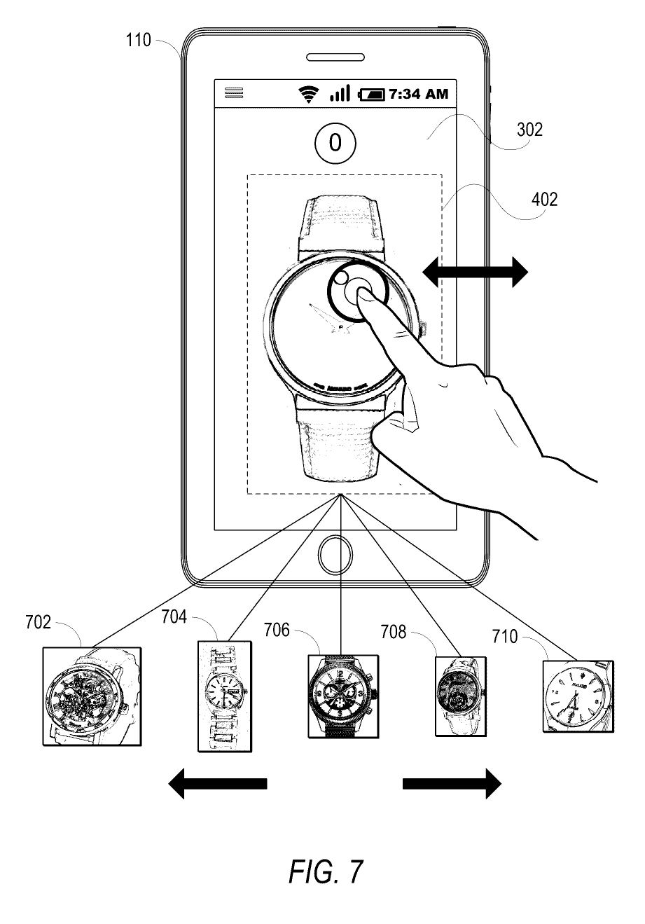

Furthermore, the disclosed modules 208 address the difficulty with providing a smooth transition between images. As the input component of the client device 110 is likely to display more pixels (either horizontally or vertically) than there are images, the modules 208 include a device capability module 216 that determines the capabilities of the input component of the client device 110 and the number of pixels that are to be traversed before an image is changed or, as discussed below with reference to FIG. 7, a displayed search result is changed. In this way, as the user traverses the input component with a finger or other input device, the images or displayed search results change in a uniform manner and in a visually perceptible manner.

In one embodiment, the device capability module 216 queries the operating system of the client device 110 (or other component manager) to obtain the capabilities of an input component of the client device 110. Such capabilities may include a horizontal pixel density, a vertical pixel density, a horizontal sampling rate, a vertical sampling rate, a horizontal size of the client device 110, a vertical size of the client device 110, and other such capabilities or combination of capabilities. The result of this query is then stored as device capability data 230. In one embodiment, an image change frequency (e.g., how frequently an image changes when a gesture is detected in the vertical direction) is based on the vertical pixel density, the vertical size of the client device 110, and a number of pixels being touched or activated by the user. Similarly, a displayed search result frequency (e.g., how frequently a displayed search result changes when a gesture is detected in the horizontal direction) is based on the horizontal pixel density, a horizontal size of the device, and a number of pixels being touched or activated by the user. In one embodiment, the change frequencies are stored as change rate data 228.

In one embodiment, image change frequency and/or the displayed search result frequency does not depend on the number of items in the search result or the number of returned search results. The experience is kept constant by keeping the frequencies only dependent on the pixel density, the size of the device, and the width of the detected touch. In this embodiment, to traverse a large number of items, the user slides the input device (e.g., his or her finger) all the way to the end of the input component (e.g., the display of the client device 110) and then “wrap around” to continue on to the next search results.

In another embodiment, the device capability module 216 determines a first ratio (V) between the number of pixels being touched and the number of vertical pixels and a second ratio (H) that includes the number of pixels being touched and the number of horizontal pixels. In this embodiment, the first ratio is then multiplied by the total number of images associated with the displayed search result 402 and the second ratio is then multiplied by the total number of search results or, in the event that the total number of search results exceed a predetermined threshold, a portion of the total number of the search results. These values then indicate the number of touched pixels a finger or other input device should traverse vertically or horizontally before a different image or different search result, respectively, is displayed.

FIG. 7 illustrates a user further interacting with the user interface 302 to change a displayed search result 402, according to an example embodiment. As shown in FIG. 7, the search results received from the networked system 102 include search results 702-710. As discussed above, while the user interface 302 is operating in the second operating mode, a user may change the search result displayed by moving an input device (e.g., a finger, a stylus) across the input component (e.g., a touch-sensitive display) of the client device 110. As the user moves the input device horizontally (e.g., transverse to) across the input component, the gesture module 218 interprets the horizontal movement as a command to change the displayed search result. In one embodiment, by moving the input device horizontally left across the input component, the gesture module 218 interprets this movement as a command to change to a “previous” search result (e.g., from search result 706 to search result 704), which is then communicated to the user interface module 212, which then performs the change in the displayed search result accordingly. Similarly, by moving the input device horizontally right across the input component, the gesture module 218 interprets this movement as a command to change to the “next” search result (e.g., from search result 706 to search result 708), which is then communicated to the user interface module 212, which then performs the change in the displayed search result accordingly. Furthermore, and as discussed above, the user interface module 212 is configured to change the displayed search result according to the displayed search result frequency determined by the device capability module 216.

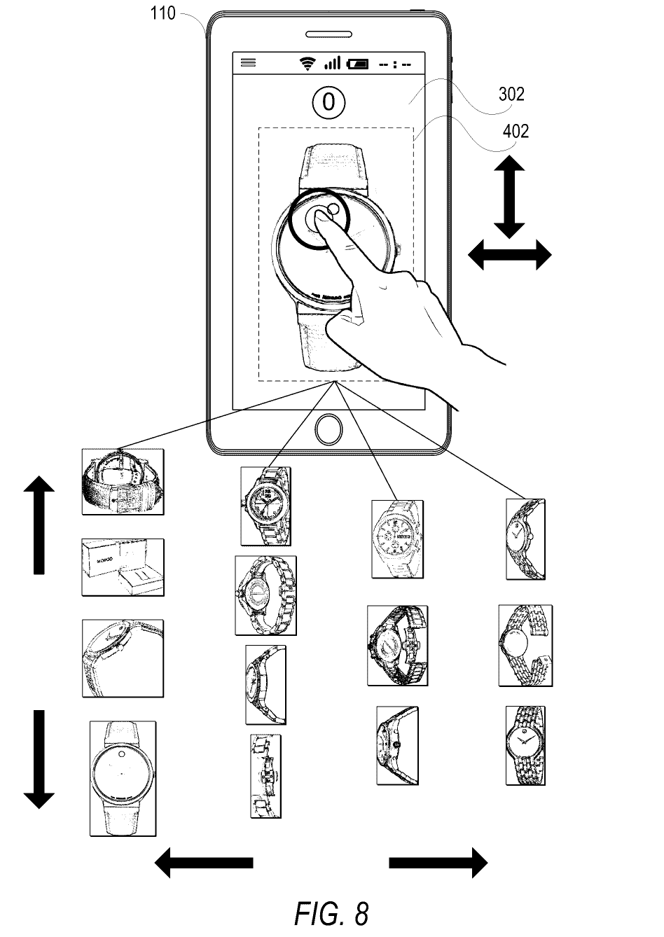

In view of the descriptions regarding FIGS. 6-7, it can be seen that the disclosed user interface 302 and user interface module 212 operate multi-dimensionally. In other words, different directions of movement by an input device across the input component of the client device 110 provide different corresponding commands to the user interface 302. To illustrate the technical advantage of this feature, FIG. 8 illustrates the various ways a user may change a displayed search result or an image of the displayed search result using the user interface 302, according to an example embodiment. As can be seen in FIG. 8, a user can change the image displayed to one of 14 other images of the received search results; notably, these changes can be performed without the user having to lift the input device from the surface of the input component. Thus, unlike other user interfaces, a user can quickly view search results without distractions from irrelevant or non-important content.

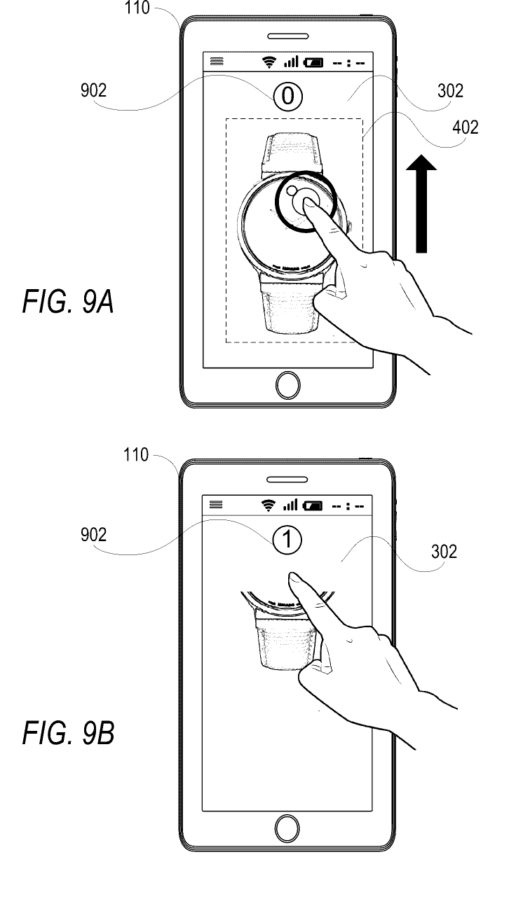

In addition to being able to view the received search results, and the various images thereof, the disclosed modules 208 provide a mechanism by which a user may store a given search result for later review. FIGS. 9A-9B illustrate an interaction by the user with the user interface 302 for saving a displayed search result 402 for later review, according to an example embodiment. In one embodiment, a physical gesture is associated with a command to save the displayed search result 402 for later review. For example, the physical gesture may be a vertical physical gesture relative to the input component of the client device 110. The command associated with the physical gesture for saving a displayed search result 402 may be distinguishable from the command associated with the physical gesture for displaying another search result based on differences in one or more of the parameters that define each of the commands. For example, a contact duration parameter for the “save” command may have a time value that is less than a contact duration parameter for the “next search result” command. This is because the “save” command is performed quicker than the “next search result” command, which means that an input device (e.g., the user's finger) is in contact with the input component of the client device 110 for a shorter period of time. As another example, a pressure parameter for the “save” command may have a value that is less than a pressure parameter for the “next search result” command; this is also because the input device is in less contact with the input component of the client device 110 when performing the “save” command than when performing the “next search result” command. In yet another embodiment, the gesture module 218 interprets the physical gesture as the “save” command by comparing one or more parameters used in determining commands corresponding to physical gestures (e.g., a pressure parameter indicating the amount of pressure being applied to the input component, a duration parameter indicating the amount of time the input component is being touched, ratio of pixels being touched to pixels not being touched).

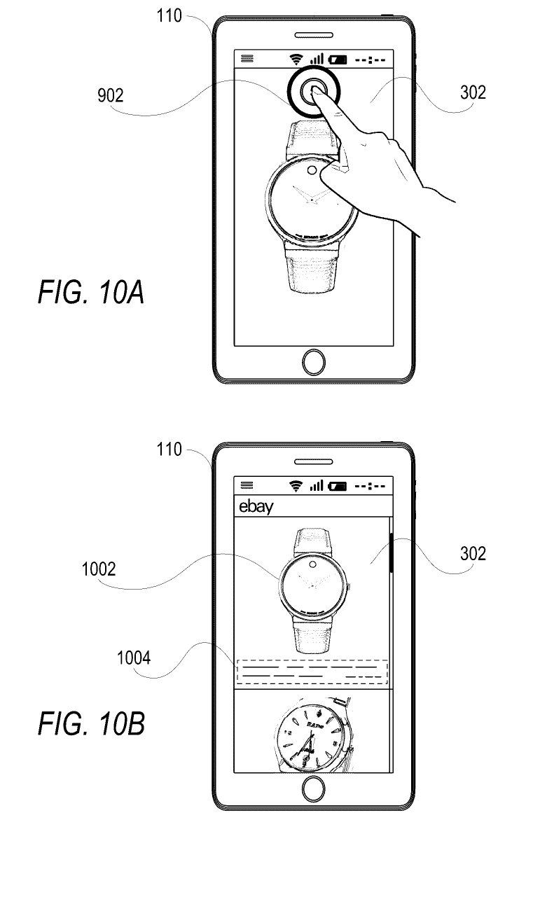

In one embodiment, saving a search result creates an entry in saved results data 232 of the data 210. The entry may include a reference (e.g., an identifier) to the saved search result in the search results data 224. In addition, a review activation element 902 (discussed further below with reference to FIGS. 10A-10B), indicates the number of search results saved by the user. In one embodiment, the review activation element 902 is a graphical button displayed by the user interface 302 and selectable by the user. Further still, and in one embodiment, when a search is saved (e.g., upon completion of creating the entry in the saved results data 232), the user interface module 212 invokes a synchronization module 220, which synchronizes the saved search results with a profile of the user residing on the networked system 102 (e.g., a profile stored in one or more databases 126). In this manner, should the client device 110 lose connectivity with the networked system 102, the user may retrieve the saved search results from the networked system 102.

After saving one or more search results, a user may review the saved search results. Accordingly, and in one embodiment, the user interface module 212 is configurable to operate in a third operating mode, the third operating mode facilitating review of the previously saved search results. FIGS. 10A-10B illustrate the user interacting with a review activation element 902 displayable by the user interface 302 that causes the user interface module 212 to enter a third operating mode, according to an example embodiment. In the third operating mode, the user interface 302 displays the saved search results, including a primary image 1002 and textual information 1004 associated with a corresponding saved search result. In addition, the display of the search results may be scrollable, such that a user may review the saved search results by touching the input component of the client device 110 and performing a physical gesture interpretable by the gesture module 218. While in the third operating mode, an upward vertical physical gesture (relative to the input component of the client device 110) causes the user interface 302 to scroll downwards such that additional saved search results are displayed, whereas a downward vertical physical gesture causes the user interface 302 to scroll upwards such that previously viewed saved search results are then re-displayed via the user interface 302.

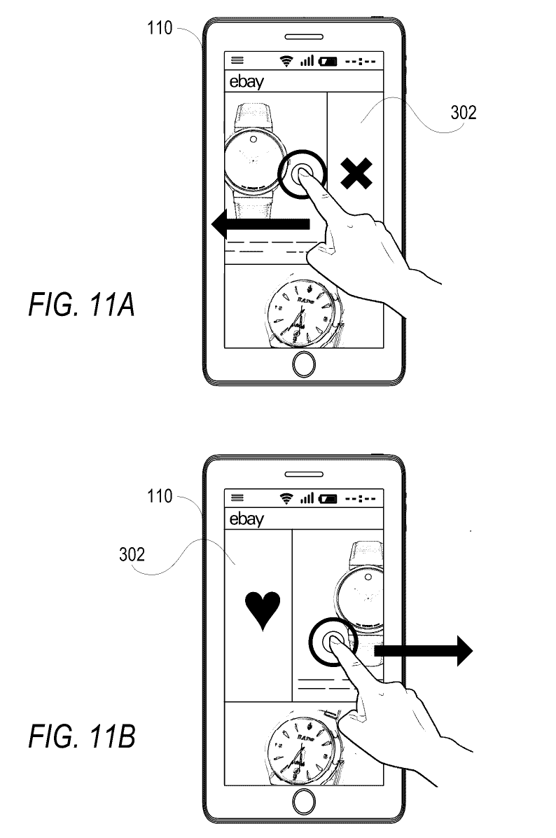

While viewing the saved search results, a user can indicate whether he or she desires to purchase a given saved search result. Accordingly, while in third operating mode, the user interface 302 is configured to receive horizontal physical gestures that indicate whether the user desires to purchase a given saved search result or remove the saved search result from the saved search results data 232. FIGS. 11A-11B illustrate the user interacting with the user interface 302 operating in the third operating mode, according to an example embodiment, where the interactions indicate whether a given saved search result is to be purchased or removed. In one embodiment, and as shown in FIG. 11A, a leftward horizontal physical gesture by an input device (e.g., the user's finger) relative to the input component (e.g., the touch-sensitive display) indicates that a given saved search result is to be removed from the saved search results data 232. Similarly, and as shown in FIG. 11B, a rightward horizontal physical gesture by the input device relative to the input component indicates that a given saved search result is to be purchased by the user. In some embodiments, the user may be afforded the opportunity to confirm the saved search result is to be purchased. For example, when the input device completes the rightward horizontal physical gesture, the gesture module 218 may inform the user interface module 212 of the corresponding command to purchase the saved search result, which then may invoke the synchronization module 220, which further instructs the networked system 102 that the saved search result should be placed in an electronic shopping cart to be later reviewed and/or confirmed by the user before the purchase is completed. Further still, the electronic shopping cart may be associated with the user's profile so that the user can use a different device, such as a desktop computer, to complete the purchase of the saved search result.

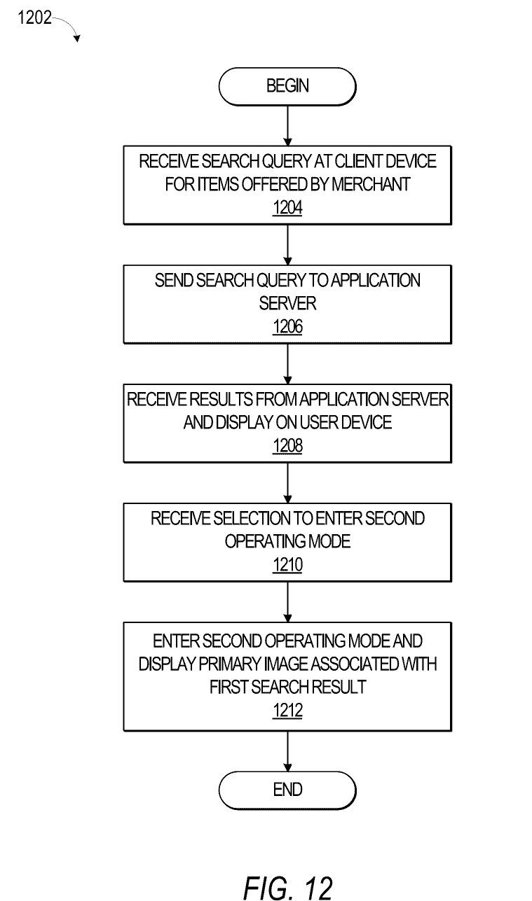

FIG. 12 illustrate a flowchart of a method 1202, according to an example embodiment, for causing the user interface to enter the second operating mode. The method 1202 may be implemented by one or more of the modules 208 of the client device 110 and, accordingly, is merely described by way of reference thereto. Initially, and with reference to FIGS. 2-3, the user interface module 212 provides a user interface 302 for facilitating interactions between a user of the client device 110 and the networked system 102. A search query element 304 displayed by the user interface 302 receives a search query from the user, which is processed by the search query module 214 (Operation 1204). The search query module then communicates the received search query to the network system 102, such as the application server 140, by way of one or more communication interfaces 202 (Operation 1206). The search query module 214 then receives a reply from the application server 140, which may include one or more search results for display by the user interface 302 (Operation 1208). As discussed above, the search results may include items offered by one or more merchants, and each result may include a primary image, one or more additional images, and textual information describing the search result.

Thereafter, a user may invoke the second operating mode of the user interface module 212. As discussed, a user invokes the second operating mode by interacting with (e.g., tapping or clicking) a selectable element 308 displayed on the user interface 302 (Operation 1210). The user interface module then enters the second operating mode and modifies the displayed user interface 302 accordingly. As discussed above, when the user interface module 212 initially enters the second operating mode, the user interface module may cause the user interface 302 to display the first search result received from the networked system 102, including a primary image associated therewith (Operation 1212).

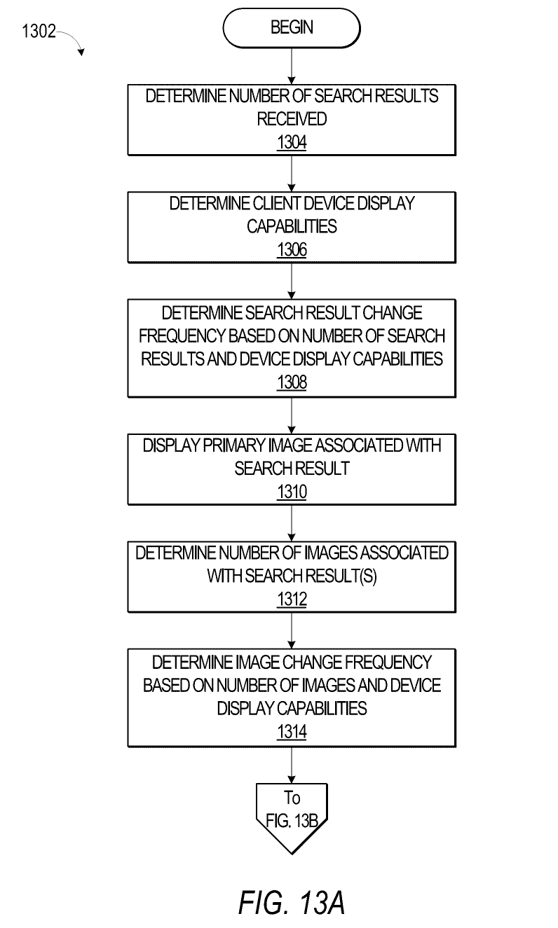

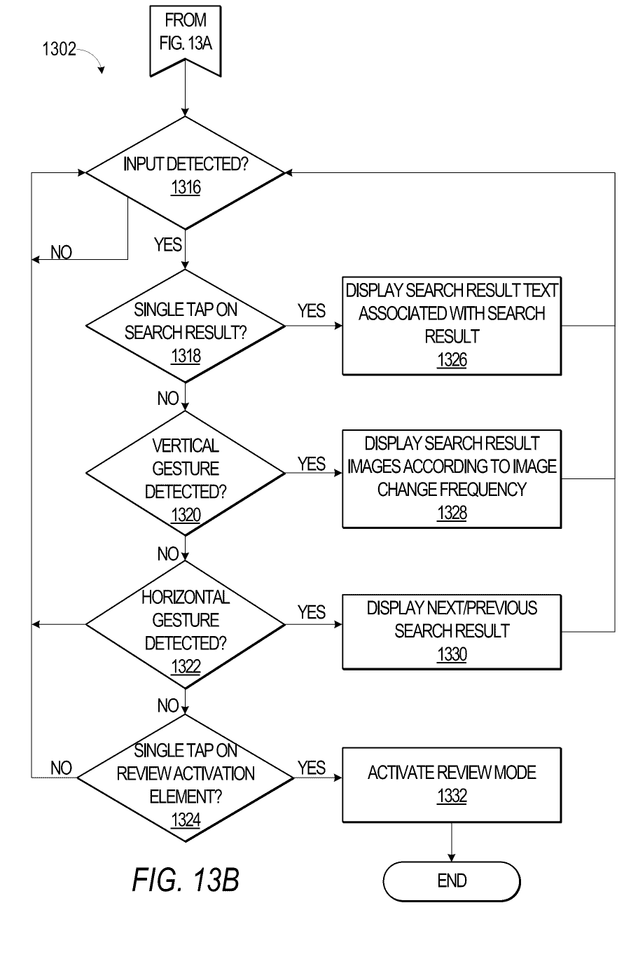

After entering the second operating mode, the user may view one or more of the received search results as previously discussed with regard to FIGS. 4-9B. Accordingly, FIGS. 13A-13B illustrate a flow chart of a method 1302, according to an example embodiment, for interacting with the user interface operating in the second operating mode. The method 1302 may be implemented by one or more of the modules 208 and is merely described by way of reference thereto.

Referring first to FIG. 13A, and in one embodiment, the device capability module 216 initially determines the image change frequency value and the displayed search result frequency value (e.g., the change rate data 228). Initially, the device capability module 216 determines the number of search results received (Operation 1304) and the client device display capabilities (Operation 1306). As discussed above, the client device display capabilities may be determined by querying an operating system or other component of the client device 110 according to an application programming interface (API) associated with the operating system or other component. The device capability module 216 then determines the search result change frequency based on the received number of search results and the device display capabilities (Operation 1308). As discussed with reference to FIG. 6, the search result change frequency is derived from a ratio of touched and untouched pixels, and the number of search results to display on the user interface 302.

The user interface 302 then displays the primary image associated with a given search result (e.g., the first search result received) (Operation 1310). The device capability module 216 then determines the number of images associated with the displayed search result and/or the received search results (Operation 1312). The device capability module 216 then determines the image change frequency based on the number of images associated with the displayed search result and the device display capabilities (Operation 1314). As also discussed with reference to FIG. 6, the image change frequency is derived from a ratio of touched and untouched pixels, and the number of images associated with a corresponding search result 302.

Referring to FIG. 13B, the user interface module 212 and the gesture module 218 then wait for input from the user (Operation 1316). If no input is detected (“No” branch from Operation 1316), the user interface module 212 and the gesture module 218 continue waiting for input (e.g., polling for input). When input is detected (“Yes” branch from Operation 1316), the gesture module 218 determines whether the received input was a single tap on a displayed search result (Operation 1318). If this is determined in the affirmative (“Yes” branch of Operation 1318), the gesture module 218 then instructs the user interface module 212 to display textual information (e.g., search result text) associated with the displayed search result (Operation 1326). As discussed above, the textual information may be stored as a portion of the received search results data 224 and retrieved therefrom.

Should the gesture module 218 determine that the received input was not a single tap on a displayed search result (“No” branch of Operation 1318), the gesture module 218 determines whether the received input was a vertical gesture (Operation 1320). If this is determined in the affirmative (“Yes” branch of Operation 1320), the gesture module 218 then instructs the user interface module 212 to change the image(s) of the displayed search result according to the image change frequency and the direction of the vertical gesture (Operation 1328). As discussed above, FIG. 6 illustrates changing the image of a displayed search result.

Should the gesture module 218 determine that the received input was not a vertical gesture, (“No” branch of Operation 1320), the gesture module 218 determines whether the received input was a horizontal gesture (Operation 1322). If this is determined in the affirmative (“Yes” branch of Operation 1322), the gesture module 218 then instructs the user interface module 212 to change the displayed search result to the next or previous search result according to the displayed search result frequency and the direction of the vertical gesture (Operation 1330). As discussed above, FIG. 7 illustrates changing the displayed search result.

Should the gesture module 218 determine that the received input was not a horizontal gesture, (“No” branch of Operation 1320), the gesture module 218 determines whether the received input was a single tap on the review activation element 902 (Operation 1324). If this is determined in the affirmative (“Yes” branch of Operation 1324), the gesture module 218 then instructs the user interface module 212 to operate in the third operating mode (e.g., the review mode) and to change the user interface 302 accordingly (Operation 1332). As discussed above, FIGS. 10A-10B illustrate the user interacting with the review activation element 902. Should this be determined in the negative (“No” branch of Operation 1324), then the gesture module 218 determines that the input was for another component of the client device 110, in which case, operational flow returns to Operation 1316.

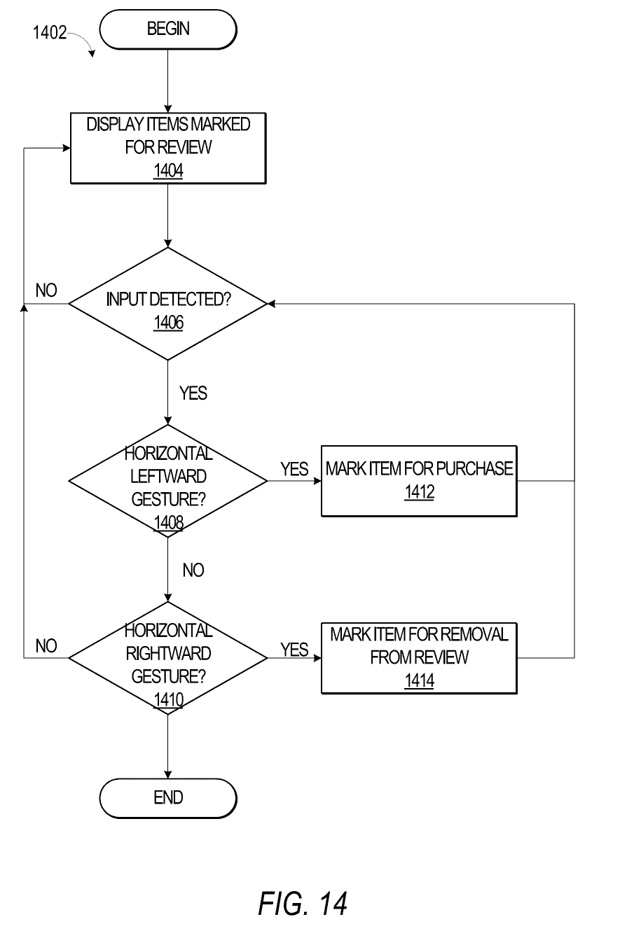

FIG. 14 illustrates a flow chart of a method 1402, according to an example embodiment, for interacting with the user interface 302 operating in the third operating mode. Initially, the user interface 302 displays those search results that the user previously indicated should be saved for review (Operation 1404). The user interface module 212 and the gesture module 218 then await input from the user (Operation 1406). Where there is no input detected (“No” branch of Operation 1406), the user interface module 212 and the gesture module 218 continue waiting for input. Where there is input detected (“Yes” branch of Operation 1406), the gesture module 218 determines the type of input received. The gesture module 218 may first determine whether the received input is a horizontal leftward gesture (Operation 1408). If so (“Yes” branch of Operation 1408), the gesture module 218 instructs the user interface module 212 that the displayed search should be saved for later purchasing by the user (Operation 1412). If not (“No” branch of Operation 1408), the gesture module 218 may then determine whether the received input is a horizontal rightward gesture (Operation 1410). If so, (“Yes” branch of Operation 1410), the gesture module 218 instructs the user interface module 212 that the displayed search result should be removed from review (Operation 1414). If not (“No” branch of Operation 1410), then gesture module 218 may ignore the input. However, some inputs, like a vertical gesture, may be interpreted as a command to scroll through the saved search results.

While the foregoing description of the various modules 208 has discussed certain gestures relative to an input component of the client device 110, one of ordinary skill in the art will recognize that modifications to these gestures may be possible without departing from the spirit and scope of this disclosure. Thus, in some embodiments, vertical and/or horizontal gestures may be directionally swapped, vertical gestures may be changed to horizontal gestures and vice versa, and other such changes. These changes are considered as falling within the scope of this disclosure and to be equivalents to the embodiments discussed herein.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine Architecture

The modules, methods, applications and so forth described in conjunction with FIGS. 2-14 are implemented in some embodiments in the context of a machine. The sections below describe a representative machine (e.g., hardware) architecture suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Example Machine Architecture and Machine-Readable Medium

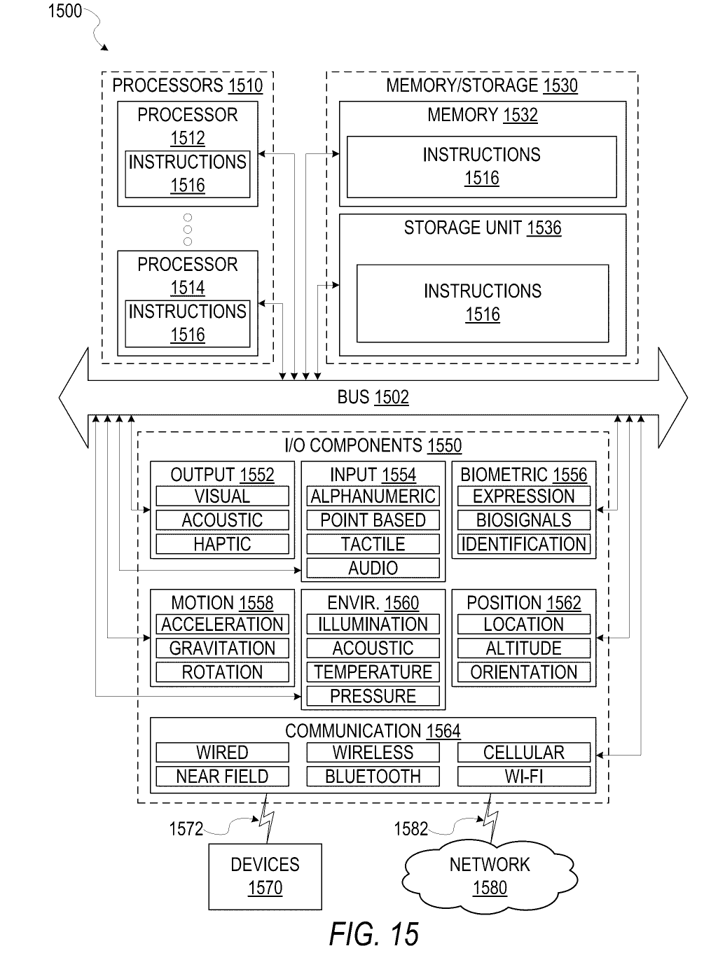

FIG. 15 is a block diagram illustrating components of a machine 1500, according to some example embodiments, able to read instructions from a machine-readable medium (e.g., a machine-readable storage medium) and perform any one or more of the methodologies discussed herein. Specifically, FIG. 15 shows a diagrammatic representation of the machine 1500 in the example form of a computer system, within which instructions 1516 (e.g., software, a program, an application, an applet, an app, or other executable code) for causing the machine 1500 to perform any one or more of the methodologies discussed herein may be executed. For example the instructions may cause the machine to execute the flow diagrams of FIGS. 12-14. Additionally, or alternatively, the instructions may implement one or more of the modules 208 illustrated in FIG. 2. The instructions transform the general, non-programmed machine into a particular machine programmed to carry out the described and illustrated functions in the manner described. In alternative embodiments, the machine 1500 operates as a standalone device or may be coupled (e.g., networked) to other machines. In a networked deployment, the machine 1500 may operate in the capacity of a client machine in a server-client network environment or as a peer machine in a peer-to-peer (or distributed) network environment. The machine 1500 may comprise, but not be limited to, a client computer, a personal computer (PC), a tablet computer, a laptop computer, a netbook, a personal digital assistant (PDA), a cellular telephone, a smart phone, a mobile device, a wearable device (e.g., a smart watch), a smart home device (e.g., a smart appliance), other smart devices, or any machine capable of executing the instructions 1516, sequentially or otherwise, that specify actions to be taken by machine 1500. Further, while only a single machine 1500 is illustrated, the term “machine” shall also be taken to include a collection of machines 1500 that individually or jointly execute the instructions 1516 to perform any one or more of the methodologies discussed herein.

The machine 1500 may include processors 1510, memory 1530, and I/O components 1550, which may be configured to communicate with each other such as via a bus 1502. In an example embodiment, the processors 1510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1512 and processor 1514 that may execute instructions 1516. The term “processor” is intended to include multi-core processor that may comprise two or more independent processors (sometimes referred to as “cores”) that may execute instructions contemporaneously. Although FIG. 15 shows multiple processors, the machine 1500 may include a single processor with a single core, a single processor with multiple cores (e.g., a multi-core process), multiple processors with a single core, multiple processors with multiples cores, or any combination thereof.

The memory/storage 1530 may include a memory 1532, such as a main memory, or other memory storage, and a storage unit 1536, both accessible to the processors 1510 such as via the bus 1502. The storage unit 1536 and memory 1532 store the instructions 1516 embodying any one or more of the methodologies or functions described herein. The instructions 1516 may also reside, completely or partially, within the memory 1532, within the storage unit 1536, within at least one of the processors 1510 (e.g., within the processor's cache memory), or any suitable combination thereof, during execution thereof by the machine 1500. Accordingly, the memory 1532, the storage unit 1536, and the memory of processors 1510 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1516. The term “machine-readable medium” shall also be taken to include any medium, or combination of multiple media, that is capable of storing instructions (e.g., instructions 1516) for execution by a machine (e.g., machine 1500), such that the instructions, when executed by one or more processors of the machine 1500 (e.g., processors 1510), cause the machine 1500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1550 may include a wide variety of components to receive input, provide output, produce output, transmit information, exchange information, capture measurements, and so on. The specific I/O components 1550 that are included in a particular machine will depend on the type of machine. For example, portable machines such as mobile phones will likely include a touch input device or other such input mechanisms, while a headless server machine will likely not include such a touch input device. It will be appreciated that the I/O components 1550 may include many other components that are not shown in FIG. 15. The I/O components 1550 are grouped according to functionality merely for simplifying the following discussion and the grouping is in no way limiting. In various example embodiments, the I/O components 1550 may include output components 1552 and input components 1554. The output components 1552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1554 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1550 may include biometric components 1556, motion components 1558, environmental components 1560, or position components 1562 among a wide array of other components. For example, the biometric components 1556 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1558 may include acceleration sensor components (e.g., accelerometer), gravitation sensor components, rotation sensor components (e.g., gyroscope), and so forth. The environmental components 1560 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1562 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1550 may include communication components 1564 operable to couple the machine 1500 to a network 1580 or devices 1570 via coupling 1582 and coupling 1572 respectively. For example, the communication components 1564 may include a network interface component or other suitable device to interface with the network 1580. In further examples, communication components 1564 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1570 may be another machine or any of a wide variety of peripheral devices (e.g., a peripheral device coupled via a Universal Serial Bus (USB)).

Moreover, the communication components 1564 may detect identifiers or include components operable to detect identifiers. For example, the communication components 1564 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1564, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1580 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1580 or a portion of the network 1580 may include a wireless or cellular network and the coupling 1582 may be a Code Division Multiple Access (CDMA) connection, a Global System for Mobile communications (GSM) connection, or other type of cellular or wireless coupling. In this example, the coupling 1582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1516 may be transmitted or received over the network 1580 using a transmission medium via a network interface device (e.g., a network interface component included in the communication components 1564) and utilizing any one of a number of well-known transfer protocols (e.g., hypertext transfer protocol (HTTP)). Similarly, the instructions 1516 may be transmitted or received using a transmission medium via the coupling 1572 (e.g., a peer-to-peer coupling) to devices 1570. The term “transmission medium” shall be taken to include any intangible medium that is capable of storing, encoding, or carrying instructions 1516 for execution by the machine 1500, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a gesture module, implemented by at least one processor of a machine, configured to determine a command selected from a plurality of commands, each command corresponding to a physical gesture performed on an input component of the machine; and
a user interface module, implemented by the at least one processor, configured to:
display, in a first operating mode of a user interface, a plurality of search results received in response to a received search query;
in response to a first command determined by the gesture module based on a first gesture received by the input component, change the operating mode of the user interface to a second operating mode, the second operating mode causing the user interface to display a single search result at a time on the display of the machine when operating in the second operating mode; and
in response to a second command determined by the gesture module based on a second gesture received by the input component, change the search result displayed on the display or change an image of the search result displayed on the display, the change in the displayed search result is caused by the second gesture being in a first direction and the change in the image of the search result displayed is caused by the second gesture being in a second direction.

2. The system of claim 1, further comprising a device capability module configured to determine display capabilities of the machine, the display capabilities comprising a horizontal pixel density and a vertical pixel density; and
wherein the changes to the search result displayed or the changes to the image of the search result displayed are based on at least one of the determined horizontal pixel density or the vertical density.

3. The system of claim 1, wherein:
the input component includes a predetermined number of pixel columns;
the first direction includes horizontal contact with the input component; and
the user interface module is further configured to change the displayed search result based on the number of pixel columns traversed by a digit of a user in the first direction.

4. The system of claim 1, wherein:
the input component includes a predetermined number of pixel rows;
the second direction includes vertical contact with the input component; and
the user interface module is further configured to change the image of the search result displayed based on the number of pixel rows traversed by a digit of a user in the second direction.

5. The system of claim 1, wherein:
the plurality of commands comprise:
a change search result displayed command, the change search result displayed command causing the user interface module to change the search result displayed on the display of the machine, and
a save search result command, the save search result command causing the displayed search result to be saved for later review;
the change search result displayed command is associated with a first vertical physical gesture;
the save search result command is associated with a second vertical physical gesture; and
the change search result displayed command is distinguishable from the save search result command in that the first vertical physical gesture is defined by the input component being in physical contact for a longer duration of time than the second vertical physical gesture.

6. The system of claim 1, wherein the user interface module is further configured to:
display a selectable activation element on the display of the machine; and
enter a third operating mode in response to the selection of the activation element, the third operation mode causing the user interface module to display a list of previously saved search results, the previously saved search results having been selected from the plurality of search results.

7. The system of claim 6, wherein the user interface module is further configured to:
remove a displayed previously saved search result in response to a command determined by the gesture module in response to a received third gesture, the third gesture being a horizontal leftward physical gesture; and
store the displayed previously saved search result in a synchronized networked repository in response to a further command determined by the gesture module in response to a received fourth gesture, the fourth gesture being a horizontal rightward physical gesture.

8. A method comprising:
implementing, by at least one processor of a machine, a gesture module configured to determine a command selected from a plurality of commands, each command corresponding to a physical gesture performed on an input component of the machine;
displaying on a display of the machine, a user interface operating in a first operating mode, the user interface displaying a plurality of search results received in response to a received search query;
changing, in response to a first command determined by the gesture module based on a first gesture received by the input component, the operating mode of the user interface to a second operating mode, the second operating mode causing the user interface to display a single search result at a time on the display of the machine when operating in the second operating mode; and
changing, in response to a second command determined by the gesture module based on a second gesture received by the input component, the search result displayed on the display or change an image of the search result displayed on the display, the change in the displayed search result is caused by the second gesture being in a first direction and the change in the image of the search result displayed is caused by the second gesture being in a second direction.

9. The method of claim 8, further comprising:
determining display capabilities of the machine, the display capabilities comprising a horizontal pixel density and a vertical pixel density; and
wherein the changes to the search result displayed or the changes to the image of the search result displayed are based on at least one of the determined horizontal pixel density or the vertical density.

10. The method of claim 8, wherein:
the input component includes a predetermined number of pixel columns;
the first direction includes horizontal contact with the input component; and
the method further comprises changing the displayed search result based on the number of pixel columns traversed by a digit of a user in the first direction.

11. The method of claim 8, wherein:
the input component includes a predetermined number of pixel rows;
the second direction includes vertical contact with the input component; and
the method further comprises changing the image of the search result displayed based on the number of pixel rows traversed by a digit of a user in the second direction.

12. The method of claim 8, wherein:
the plurality of commands comprise:
a change search result displayed command, the change search result displayed command causing the user interface module to change the search result displayed on the display of the machine, and
a save search result command, the save search result command causing the displayed search result to be saved for later review;
the change search result displayed command is associated with a first vertical physical gesture;
the save search result command is associated with a second vertical physical gesture; and
the change search result displayed command is distinguishable from the save search result command in that the first vertical physical gesture is defined by the input component being in physical contact for a longer duration of time than the second vertical physical gesture.

13. The method of claim 8, further comprising:
displaying a selectable activation element on the display of the machine; and
causing the user interface to enter a third operating mode in response to the selection of the activation element, the third operation mode causing the user interface to display a list of previously saved search results, the previously saved search results having been selected from the plurality of search results.

14. The method of claim 13, further comprising:
removing a displayed previously saved search result in response to a command determined by the gesture module in response to a received third gesture, the third gesture being a horizontal leftward physical gesture; and
storing the displayed previously saved search result in a synchronized networked repository in response to a further command determined by the gesture module in response to a received fourth gesture, the fourth gesture being a horizontal rightward physical gesture.

15. A machine-readable medium having no transitory signals and comprising computer-executable instructions stored thereon that, when executed by at least one processor of a machine, cause the machine perform operations comprising:
determining a command selected from a plurality of commands, each command corresponding to a physical gesture performed on an input component of a machine;
displaying on a display of the machine, a user interface operating in a first operating mode, the user interface displaying a plurality of search results received in response to a received search query;
changing, in response to a first command based on a first gesture received by the input component, the operating mode of the user interface to a second operating mode, the second operating mode causing the user interface to display a single search result at a time on the display of the machine when operating in the second operating mode; and
changing, in response to a second command determined by the gesture module based on a second gesture received by the input component, the search result displayed on the display or change an image of the search result displayed on the display, the change in the displayed search result is caused by the second gesture being in a first direction and the change in the image of the search result displayed is caused by the second gesture being in a second direction.

16. The machine-readable medium of claim 15, wherein the operations further comprise:
determining display capabilities of the machine, the display capabilities comprising a horizontal pixel density and a vertical pixel density; and
wherein the changes to the search result displayed or the changes to the image of the search result displayed are based on at least one of the determined horizontal pixel density or the vertical density.

17. The machine-readable medium of claim 15, wherein:
the input component includes a predetermined number of pixel columns;
the first direction includes horizontal contact with the input component; and
the operations further comprise changing the displayed search result based on the number of pixel columns traversed by a digit of a user in the first direction.

18. The machine-readable medium of claim 15, wherein:
the input component includes a predetermined number of pixel rows;
the second direction includes vertical contact with the input component; and
the operations further comprise changing the image of the search result displayed based on the number of pixel rows traversed by a digit of a user in the second direction.

19. The machine-readable medium of claim 15, wherein:
the plurality of commands comprise:
a change search result displayed command, the change search result displayed command causing the user interface module to change the search result displayed on the display of the machine; and
a save search result command, the save search result command causing the displayed search result to be saved for later review;
the change search result displayed command is associated with a first vertical physical gesture;
the save search result command is associated with a second vertical physical gesture; and
the change search result displayed command is distinguishable from the save search result command in that the first vertical physical gesture is defined by the input component being in physical contact for a longer duration of time than the second vertical physical gesture.

20. The machine-readable medium of claim 15, wherein the operations further comprise:
displaying a selectable activation element on the display of the machine; and
causing the user interface to enter a third operating mode in response to the selection of the activation element, the third operation mode causing the user interface to display a list of previously saved search results, the previously saved search results having been selected from the plurality of search results.
